(19) United States
(12) Patent Application Publication
(10) Pub. No.: US 2024/0140138 A1
(43) Pub. Date: May 2, 2024

(54) Scissor lift wheel lifter reinstalling wheels on automobiles

(71) Applicant: George Steiner, Brossard (CA)

(72) Inventor: George Steiner, Brossard (CA)

(21) Appl. No.: 17/803,727

(22) Filed: Oct. 31, 2022

(51) Int. Cl. B60B 29/00; B60B 30/02; B62B 3/02; B62B 3/04; B62B 3/10; H02K 7/06

(52) U.S. Cl. CPC B60B 29/001; B60B 30/02; B62B 3/02; B62B 3/04; B62B 3/104; H02K 7/06; B60B 29/002; B60B 30/10

(57) ABSTRACT

An automobile wheel lifting device for the installation of wheels when automobile is on a hydraulic lift. A motorized scissor lift table holds the wheel in a stable vertical position while lifting. Vertically stable position is ensured by a stabilizing arm placed on the wheel by the mechanic with one hand only, before lifting begins. Rate of lifting is such that when the wheel mounting holes are aligned with the studs the lifting can be stopped, the wheel rotated and installed. Lifting device avoids contact with the automobile body by lifting as if the mechanic lifted by hand. Stabilizing arm does not obstruct the view of the mechanic during lifting.

### FIELD OF THE INVENTION

In this document, wheel means an automobile wheel and tire combination where the rubber tire is mounted on the metal wheel.

This invention relates to the re-installation of automobile wheels while the automobile is on the hydraulic lift in the service bay of a repair shop. And to do this without touching the automobile body and without requiring muscular exertions from the mechanic.

### BACKGROUND OF THE INVENTION

The mechanic reinstalling wheels on an automobile while it is on the hydraulic lift faces two difficulties. The first is to lift a wheel that can weighs as much as 80 lbs. Even when wheels weigh less, lifting them all day long is punishing on the body of the mechanics. As the result many has to abandon their profession because of back injury.

The second problem is that the wheel hub is locked and the five wheel mounting studs will not line up with the holes of the wheel as it arrives to be mounted on to the studs. The mechanic in the process of lifting has to turn the heavy wheel to align with the mounting studs.

The prior art consists of for example patents such as U.S. Pat. No. 9,302,543B1 in which the lifting column is not centrally placed with the lifting arm and so allowing the mechanic access to the wheel mounting studs. There are several products using similar lifting column like the Swedish Pronomic with a narrow off centre column, where the top of the column is covered with some soft material because it is likely to be in contact with the body of the automobile. The energy source for lifting is battery or air pressure readily available in automobile shops. The present invention does not use a lifting column but a scissor lift. A stabilizing arm of the invention holds the wheel stable in the vertical orientation, because while the wheel is heavy here is no torque on the stabilizer arm wheel interface when the wheel is vertical.

### OBJECTIVES OF THE INVENTION

There are 8 objectives of the invention.

Objective 1; is to lift the wheel under motorized control.

Objective 2; is to lift the wheel at a rate that allows the vertical wheel movement to be stopped when the wheel mounting holes coincide with the position of the mounting studs.

Objective 3; is to enable the wheel to be rotated by hand easily so that mounting holes can be made to align with mounting studs.

Objective 4; is to maintain the heavy wheel in the vertical position during lifting.

Objective 5; is not to obstruct access for installing the fixing nuts that hold the wheel to the hub.

Objective 6; is to allow withdrawing the lifting mechanism easily.

Objective 7; is to ensure that there is no contact with the body of the car when using the invention.

Objective 8; is to lift a wide range of wheel diameters and weights.

### SUMMARY OF THE INVENTION

The invention consists of a scissor lift table, adapted to support an automobile wheel in the vertical position on two rollers by a stabilizing arm on the top of the table. The bottom movable legs of the scissor lift are connected to a horizontally oriented bar the push/pull bar, positioned between the legs and connected to the legs.

The push/pull bar is pulled or pushed by a rotating threaded shaft, threaded into the centre of the push/pull bar. In the preferred embodiment the threaded shaft is rotated by a DC gear motor. The drive output shaft of the gear motor is oriented 90 degree to the motor drive shaft. The connection between the gear motor output and the threaded shaft is a single joint flexible coupling.

On the top of the table, in front the two rollers is inserted a stabilizing arm. The purpose of the stabilizing arm is to maintain the wheel vertical during lifting. The stabilizing arm has two parts, a vertical and a horizontal part. The vertical part consists of two hollow tubes, one tube is fixed in position to the table top and the other tube can be moved inside the fixed hollow tube. The movable tube can be locked in position inside the fixed tube.

At the end of the movable tube in a horizontal orientation is the stabilizer arm head. The head has two rollers of appropriate length spaced an appropriate distance apart. Their purpose of these rollers is to contact the tire and when the movable tube is locked to prevent the wheel from inclining from the vertical.

Electrical control of the lifting table is by a circuit whose principal component is a three position spring-loaded rocker switch. Position 1 is ON while held ON, position 2 is permanently OFF, position 3 is ON while held ON. Thus the lifting mechanism can be made to move UP or DOWN or stopped, by changing the rocker switch from position 1 to position 3.

The invention can be used to lower the wheel under motorized control. But when dismounting the wheel, mechanics generally just remove the five mounting nuts, withdraw the wheel and let it to drop to the ground, allowing it to bounce once while keeping it vertical, then roll it to the side.

### DESCRIPTION OF THE DRAWINGS

FIG. 1 Shows the wheel diameter range of the invention.

This drawing is an illustration of the diameter range of the invention. Diameter C is 34 inches.

FIG. 2 Side view of the invention in the low position. Ready to have the wheel put on.

FIG. 3 Top view of the invention.

FIG. 4 Side view of the stabilizer arm.

FIG. 4A Side view of the stabilizer arm head showing one of the freely rotating rollers. On the right is shown the locking arm of the tube lock mechanism, in the upper vertical OPEN position and in dashed lines in the lower vertical LOCKED position.

FIG. 4B Stabilizer arm head front view. Showing the two freely rotating rollers, that contact the wheel.

FIG. 4C Section AA showing the two stabilizing arm pins.

FIG. 5 Side view of the invention with the scissor table in the lowered position. The stabilizing arm is in position, with the stabilizing head in contact with the wheel on the two rollers.

FIG. 6 Side view of the invention in the full UP position.

FIG. 7 Front view of the invention in the full UP position.

FIG. 8. The control circuit of the invention. Showing the three position spring loaded control switch, the interposing relays driving the gear motor UP and DOWN, the micro switches stopping the scissor lift in the correct UP and the Down positions.

FIG. 9 The push/pull bar of the invention.

### DETAILED DESCRIPTION OF THE INVENTION

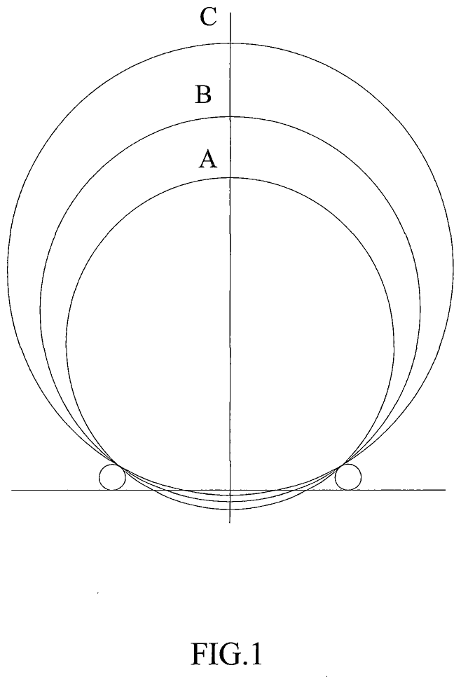

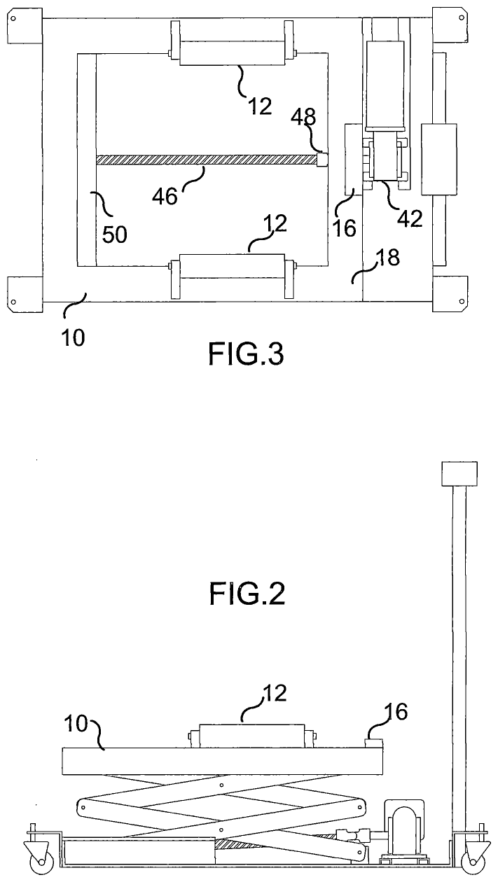

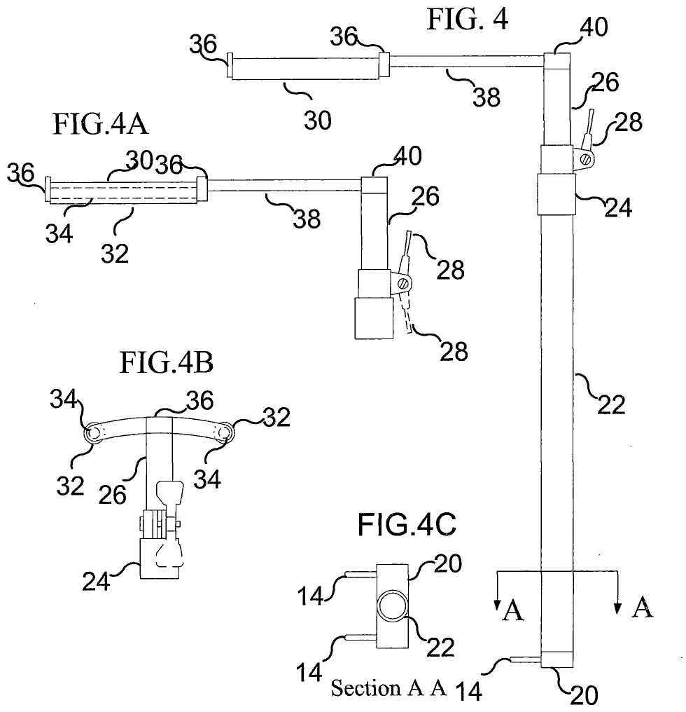

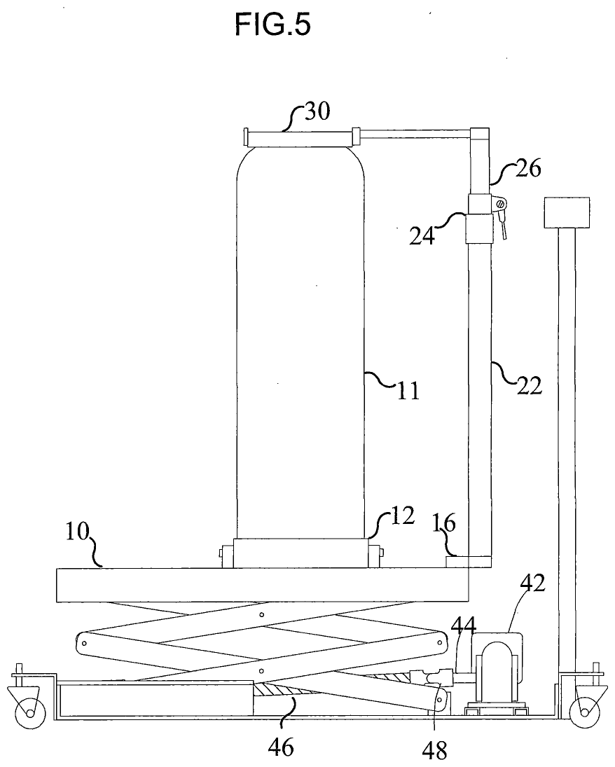

In this document the word wheel in any form means an automobile wheel with its tire mounted on it. This invention addresses the problem of reinstalling wheels on automobiles hoisted on hydraulic lifts. FIG. 1 is a dimension-ally accurate illustration of a range of automobile wheels on two rollers of this invention. FIG. 2 is a side view of the invention without a wheel mounted on it. FIG. 3 is a top view of the invention without a wheel mounted on it. The scissor lift table 10 is a lifting device such that when a wheel is put on the rollers 12 and stabilized vertically with the Stabilizer Arm shown in FIG. 4, the wheel can be lifted up in such a way as to avoid interference with and possible damage to the automobile body. Avoiding such interference is one of the important characteristic of this invention.

The stabilizing arm FIG. 4 acts as if it was the hand of a mechanic holding the wheel in the vertical position while the wheel is lifted. The bottom of the arm FIG. 4C has two parallel pins 14 spaced apart projecting a short distance. These pins 14 are inserted into the stabilizing arm receiver 16. The receiver 16 is placed centrally on the front of the lift table top 18. FIG. 4C shows the pin carrier 20.

A hollow tube of appropriate diameter and appropriate material 22 extends from the pin carrier a certain distance. On this tube 22 is fixed a lever-activated lock for telescoping tube 24. Into this lever-activated lock for telescoping tube 24, inserts a hollow tube 26 of appropriate diameter and appropriate material of a certain length. Tube 26 is movable in or out of said lever activated lock if lock lever 28 is pointing UP.

If lock lever 28 is pointing DOWN as shown in FIG. 4A dashed lines, the position of tube 26 is locked inside of tube 22. The lever activated lock allows the one handed positioning of the stabilizing arm head 30 onto the top of the wheel before lifting. The lengths of the telescoping tubes 22 and 26 are chosen so as to permit the placing of the stabilizing arm head 30 on the full range of wheel diameters of the invention.

The stabilizing arm head 30 FIG. 4A consists of two small diameter freely rotating rollers 32 held in a parallel orientation with each other in a frame composed by the shafts 34 of the rollers 32 and the two curved connectors 36, shown in FIG. 4B. Connector 38 of said arm is fixed at one end in the tube bushing 40 and at the other end in one of the curved connectors 36. The curvature of the curved connectors 36 and the diameter of rollers 32 and the distance of the rollers 32 from each other is chosen so that the rollers 32 will be in contact with the wheels over the range of wheel diameters of this invention.

The lifting action of the invention in the preferred embodiment is performed by a scissor lift table 10 under control of a DC gear motor 42 whose output drive shaft 44 is at right angle to the motor shaft. The drive shaft 44 is at mid point of the lifting table is driving a threaded screw 46 via a single jointed flexible coupling 48. The direction of the rotation of the DC gear motor 42 is controlled by the polarity of the DC voltage applied to the motor 42 and in turn controlling the direction of rotation of the crew 46. Screw 46 turns in a threaded hole 51 of a push/pull bar 50 transforming the rotating motion of the screw 46 to a linear motion of the push/pull bar 50.

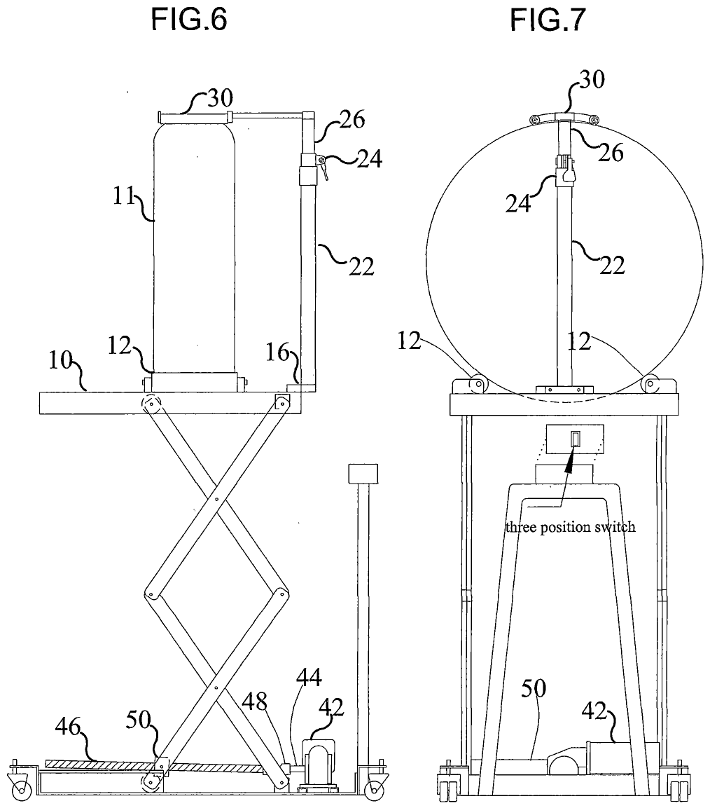

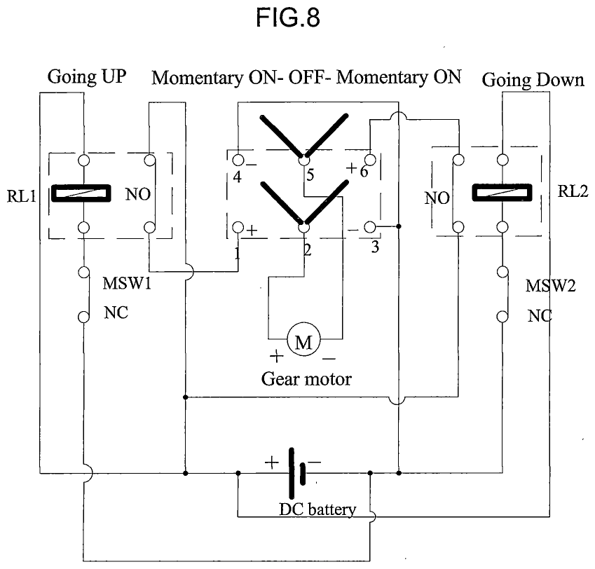

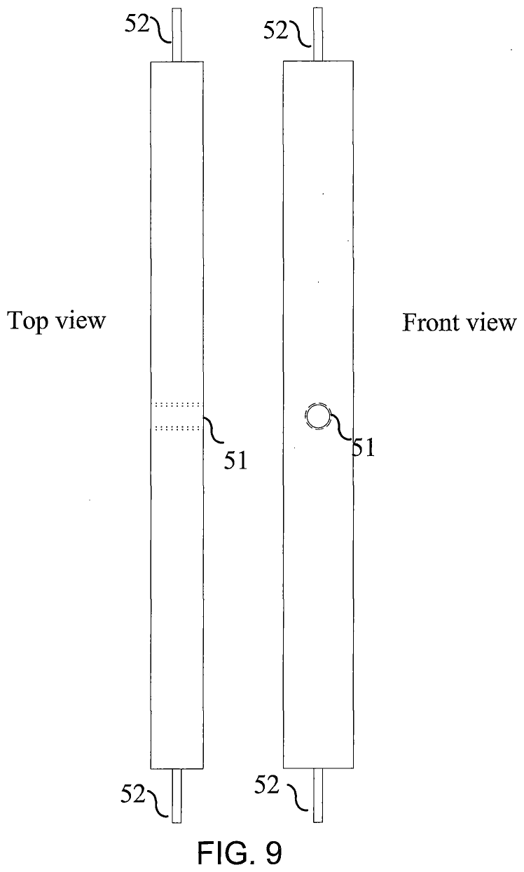

The two pins 52 anchored in the ends of the push/pull bar are inserted across the bottom scissor arms that are movable, and permit the scissor lift to be raised and lowered. See FIG. 6. The Control Circuit FIG. 8 controls the raising and lowering of the wheel. Two micro switches, not shown, activated by the position of the push/pull bar, limit the upper and lower position of the scissor lift. FIG. 6 side view and FIG. 7 front view of the lifted scissor lift table.

Although a preferred embodiment of my invention is herein disclosed, it is to be understood that this disclosure is by way of an example and variations are possible without departing from the subject matter coming within the scope of the following claims which I regard as my invention.

The embodiment of the invention in which an exclusive property or privilege is claimed are defined as follows.

1. I claim a scissor lift lifting and lowering a wheel, said wheel is supported on two rollers on top of the scissor lift table and said wheel held in a stable vertical position on top of the two rollers by an adjustable height stabilizing arm, the head of said arm contacting the top of said wheel with two spaced small diameter rollers, said scissor lift is actuated by a DC gear-motor turning a horizontally oriented threaded screw, said screw threaded into a push/pull bar transversely oriented to the threaded screw and said push/pull bar having ends connected to the two movable scissor lift legs and allowing said push/pull bar free movement in rotating.

2. Stabilizing arm claimed in claim 1 consists of two vertical telescoping tubes with one tube fixed to the scissor lift table and the other tube telescoping into the first tube with a locking mechanism attached to the first tube allowing said second tube to be fixed in position by the mechanic with one hand.

3. Stabilizing arm head claimed in claim 1 consisting of two freely rotating parallel rollers held in a frame composed of the shafts of the rollers said rollers being connected to two curved parallel members, said stabilizer arm head held horizontally by an arm and said arm is attached at one end to the head frame and the other end to the vertical movable arm member, said freely rotating rollers having diameters and spacing from each other, such that when the head is lowered on the wheel the two rollers make contact with the wheel over the range of wheel diameters claimed by this invention and hold the wheel vertical.

4. DC gear motor claimed in claim 1 where the DC voltage supplying said motor may be a battery 12 volt or 24 volt or 48 volt with the said motor drive shaft oriented 90 degree to the motor shaft said drive shaft transmitting power via a flexible coupling to a threaded shaft of suitable diameter and suitable thread such as acme thread for example.

5. DC gear motor claimed in claim 4 chosen with such speed rating as to allow raising of the wheel without overshooting the wheel mounting holes with the mounting studs by more than half a centimetre as well as having power rating such as to raise the scissor lift against horizontal resistance of several hundred pounds.

6. Two rollers on top of the scissor lift table claimed in claim 1 supporting the wheel and such rollers having length, diameter and spacing such that accommodates the range of wheel diameters shown in FIG. 1.
